(19) United States
(12) Patent Application Publication
(10) Pub. No.: US 2007/0109299 A1
(43) Pub. Date: May 17, 2007

(54) Surface-based characteristic path generation

(75) Inventor: Samuel W. Peterson, St. Paul, MN (US)

Correspondence Address: SCHWEGMAN, LUNDBERG, WOESSNER & KLUTH, P.A., P.O. BOX 2938, MINNEAPOLIS, MN, 55402, US

(73) Assignee: Vital Images, Inc.

(21) Appl. No.: 11/273,938

(22) Filed: Nov. 15, 2005

(51) Int. Cl. G06T 17/20

(52) U.S. Cl. 345/423

(57) ABSTRACT

This document discusses, among other things, systems and methods for efficiently using surface data to calculate a characteristic path of a virtual three-dimensional object. A surface mesh is constructed using segmented volumetric data representing the object. Geodesic distance from a reference point is calculated for each shape element in the surface mesh. The geodesic distance values are used to produce rings. Ring centroids are computed and connected to form the characteristic path, which is optionally pruned and smoothed.

### TECHNICAL FIELD

This document relates generally to volumetric imaging of biological or other objects, and particularly, but not by way of limitation to systems or methods to quickly determine a surface-based path through a three-dimensional representation of an object.

### BACKGROUND

In recent years, medical imaging has become a highly valuable tool for medical professionals. One common imaging technique is computed tomography (CT). The CT images, typically of one or more axial volumetric scans, are either analyzed individually by a radiologist or alternatively, they can be reconstructed into a three-dimensional (3D) model. Three-dimensional modeling has been used in a variety of clinical applications including virtual colonoscopies, virtual bronchoscopies, and virtual angioscopies. Using a computer-generated model from CT scans, a radiologist can pre-screen patients for cancer or other diseases. Using such a virtual model avoids subjecting the patient to a traditional manual endoscopy, which can be uncomfortable, expensive, and inaccurate.

There are several well-known methods used to construct a volumetric representation of an object, such as when given a set of two-dimensional scans. The most common method is segmentation. Segmentation uses the image intensity of portions of a scan to determine what portions are “inside” the object to be defined, and what portions are “outside.” Such segmentation can define a surface and volume of the scanned object. The output of such a segmentation process is a volumetric virtual object, which is typically represented by a collection of voxels (3D pixels) arranged in 3D space.

One step in certain imaging procedures includes identifying a centerline of the computer-modeled object. A centerline has several uses, including use as a virtual “flight path” for guiding a virtual tour through the 3D virtual object, such as in a virtual colonoscopy, for example. Another example is using a centerline for registering, or creating a correlation, between multiple scans of the same object, such as registering between a prone and supine scan of a colon, for example. However, centerline generation is not always computationally efficient, automated, and robust. If the centerline is intended to be used as a flight path, then centricity (ensuring that the centerline is always within the virtual object and that it closely tracks the medial center of the object) may also be desirable. Computational efficiency and automation will decrease the hands-on time needed by a user (e.g., a radiologist), thereby reducing the procedure's cost. A robust algorithm is desirable. Finally, a high degree of centricity is usually desirable, such as for using the centerline for both registration and as a flight path planning.

Several approaches to generating a centerline have been proposed. For example, topological thinning iteratively removes layers of a volumetric object until there is only one central layer remaining. This central layer of voxels defines the centerline. Topological thinning is accurate, but is very computationally expensive.

Another approach is distance mapping. Distance mapping is a two-step process. First, every voxel inside a 3D virtual object is found, and its distance from a reference point (“the source voxel”) is computed. The second step extracts the shortest path to the source voxel from any starting voxel through the gradient of the distance map. Distance mapping will yield a centerline path that stays within the interior of the 3D object, and will also typically extract the shortest path. While this method is generally faster than topological thinning, it is still computationally intensive. Also, centerlines generated using distance mapping tend to hug corners rather than following a medial axis around sharp turns. Other variations of centerline generation using the volume of the virtual object have also been explored.

### SUMMARY

The present inventors have recognized, among other things, that using the volume of a virtual object to determine its centerline is substantially more computationally expensive than using surface data of the virtual object, because of the geometric relationship between the two (e.g., as the surface area increases linearly, the volume will increase exponentially). This document discusses, among other things, systems and methods for efficiently using surface data to calculate a characteristic path of a virtual three-dimensional object. A surface mesh is constructed using segmented volumetric data representing the object. Geodesic distance from a reference point is calculated for each shape element in the surface mesh. The geodesic distance values are used to produce rings. Ring centroids are computed and connected to form the characteristic path, which is optionally pruned and smoothed.

Certain examples describe a computer-assisted method of calculating a characteristic path of a three-dimensional object represented by volumetric imaging data. In such examples, the method includes generating a geometric surface mesh of one or more geometric shapes. A reference geometric shape is designated. Distance values are assigned to the geometric shapes on the geometric surface mesh in relation to the reference geometric shape. The geometric shapes are grouped to form cross-sectional shapes that approximate circumferences of the three-dimensional object. Centroids are calculated of the cross-sectional shapes. The centroids are combined to form the characteristic path.

Certain examples describe a computer-assisted method of calculating a characteristic path of a biological structure represented by volumetric imaging data. In such examples, the method includes generating a triangular surface mesh. A reference triangle is chosen from a set of all triangles in the triangular surface mesh. A relative distance value is generated for every triangle in the set of all triangles in the triangular surface mesh in relation to the reference triangle. The triangles are grouped to form rings that approximate cross-sectional circumferences of the structure along a longitudinal axis of the structure. Centroids of the rings are calculated. The centroids are concatenated to form the characteristic path. The characteristic path is pruned to remove branches shorter than a threshold length. The characteristic path is smoothed.

Certain examples describe a computer-assisted method of calculating a characteristic path of a colon represented by a given segmentation of volumetric imaging data. In such examples, the method includes generating a triangular surface mesh using a Marching Cubes technique. A reference triangle is determined to be used as a beginning of the characteristic path. A geodesic distance value is assigned to other triangles with respect to the reference triangle. Connected triangles are grouped together according to their geodesic distance values to form a set of rings that approximate cross-sectional circumferences of the colon. A centroid is determined of each ring by using a set of centroids of all triangles in a particular ring. The centroids of each ring are concatenated to form the characteristic path. Branches that do not meet a minimum length are deleted.

Systems and computer-readable media for performing the methods are also described. This summary is intended to provide an overview of the subject matter of the present patent application. It is not intended to provide an exclusive or exhaustive explanation of the invention. The detailed description is included to provide further information about the subject matter of the present patent application.

### BRIEF DESCRIPTION OF THE DRAWINGS

In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

FIG. 1 is a schematic view of a medical scanner, an image storage device, and one or more image processing stations.

FIG. 2 is a schematic view of an exemplary image processing station.

FIG. 3 is a detailed view of a display screen.

FIG. 4 is a schematic view of a system used to calculate a characteristic path.

FIG. 5 is a perspective view of a tubular virtual three-dimensional object with an exemplary triangular mesh.

FIG. 6 is a flowchart illustrating generally the process of calculating a characteristic path through a three-dimensional object.

FIG. 7 is a flowchart illustrating generally the process of determining the reference triangle in a triangular surface mesh.

FIG. 8 is an illustration of a portion of a triangular surface mesh.

FIG. 9 is an illustration of a portion of a triangular surface mesh with geodesic distance values assigned.

FIG. 10 is an illustration of a portion of a triangular surface mesh with geodesic distance values assigned using an alternate method of assignment.

FIG. 11 is a perspective view of a tubular object illustrating one example of distance-based rings and a resulting characteristic path.

FIG. 12 is a perspective view of a tubular object illustrating another example of distance-based rings and a resulting characteristic path.

FIG. 13 is a perspective view of a tubular object illustrating yet another example of distance-based rings and a resulting characteristic path.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, logical and electrical changes may be made without departing from the scope of the present invention. The following detailed description is, therefore, not to be taken in a limiting sense, and the scope of the present invention is defined by the appended claims and their equivalents.

In this document, the terms “a” or “an” are used, as is common in patent documents, to include one or more than one. In this document, the term “or” is used to refer to a nonexclusive or, unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Introduction

The present inventors have recognized, among other things, that using volume data of an elongated virtual object (such as a colon or other biological structure) to compute its centerline is computationally expensive and therefore time-consuming. Among other things, this document describes an efficient way to determine a characteristic path of the object using surface data of the object instead of by using volume data. The characteristic path may not provide complete centricity of the object and, therefore, does not necessarily constitute a centerline. Nevertheless, the characteristic path will typically be sufficiently representative of the object to permit certain uses, such as for registering a prone scan of the object to a supine scan of the object. This is useful, for example, in a virtual colonoscopy.

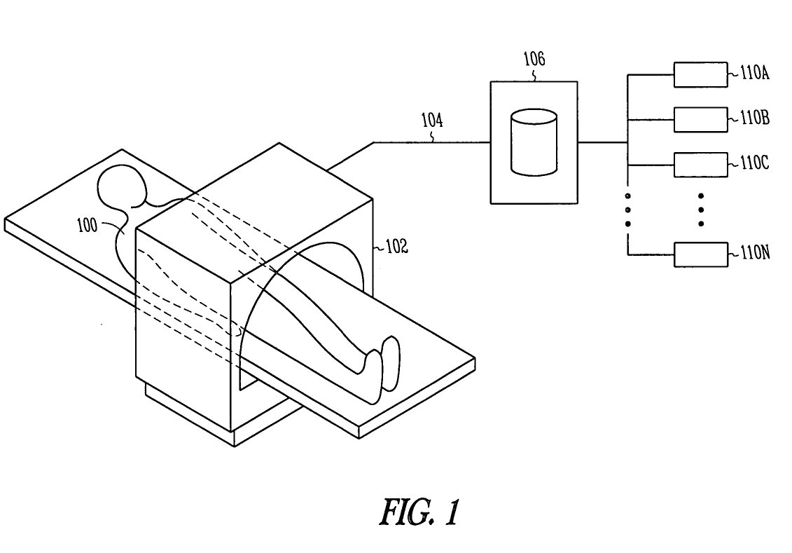

FIG. 1 illustrates an example of a system that may use this characteristic path data. In this example, a patient 100 is scanned by a typical medical imaging scanner 102. Examples of a medical imaging scanner 102 include, without limitation, a CT scanner and a magnetic resonance imaging (MRI) scanner. The scanner 102 is typically connected to a storage system 106, such as by a data pathway 104. The data pathway 104 is typically a local area network (LAN) and the storage system 106 is typically an image server. In this example, the storage system 106 is connected to one or more image processing stations 110A, 110B, 110C, . . . , 110N, by a second data pathway 108, which is typically a LAN.

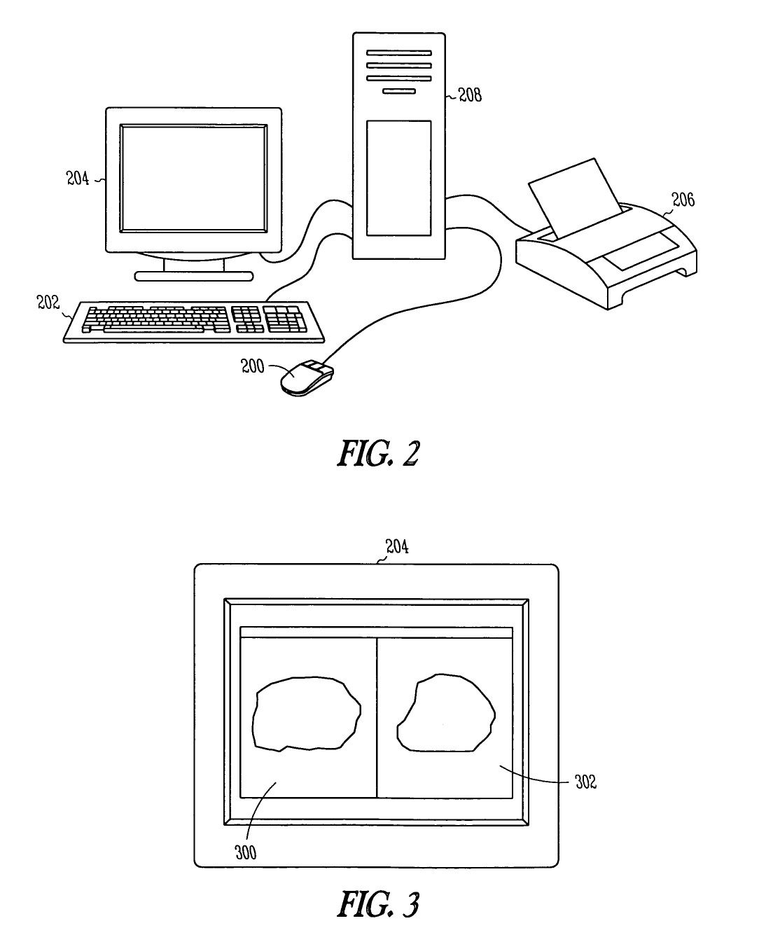

FIG. 2 illustrates a typical image processing station 110. In this example, the image processing station 110 includes one or more input devices, such as a mouse 200 and a keyboard 202, one or more output devices, such as a display 204 and a printer 206, and a control unit 208, which may include a processor, a local memory, and additional hardware to control communication between internal and external devices. The image processing station 110 computes a segmentation using the images stored at the storage system 106. A user can use the image processing station 110N to perform a method that includes generating a characteristic path using the segmentation. The characteristic path can be used to register multiple paths.

FIG. 3 illustrates a monitor 204 displaying two virtual 3D objects concurrently. In this example, each 3D virtual object is a representation of a different scan, such as a supine scan and a prone scan. For example, in a virtual colonoscopy, it is often desirable to take prone and supine scans of the colon, since residual stool content may shift between prone and supine scans making one or the other of the scans more desirable to the diagnostician. However, registering the prone and supine scans is necessary in order to translate between the same location in the prone scan to the same location in the supine scan. The diagnostician may desire to switch between such images. Alternatively, as the user maneuvers the point of view through the object's virtual interior in one view 300 (e.g., prone), the other view 302 (e.g., supine) can concurrently track using the provided registration.

### EXAMPLES

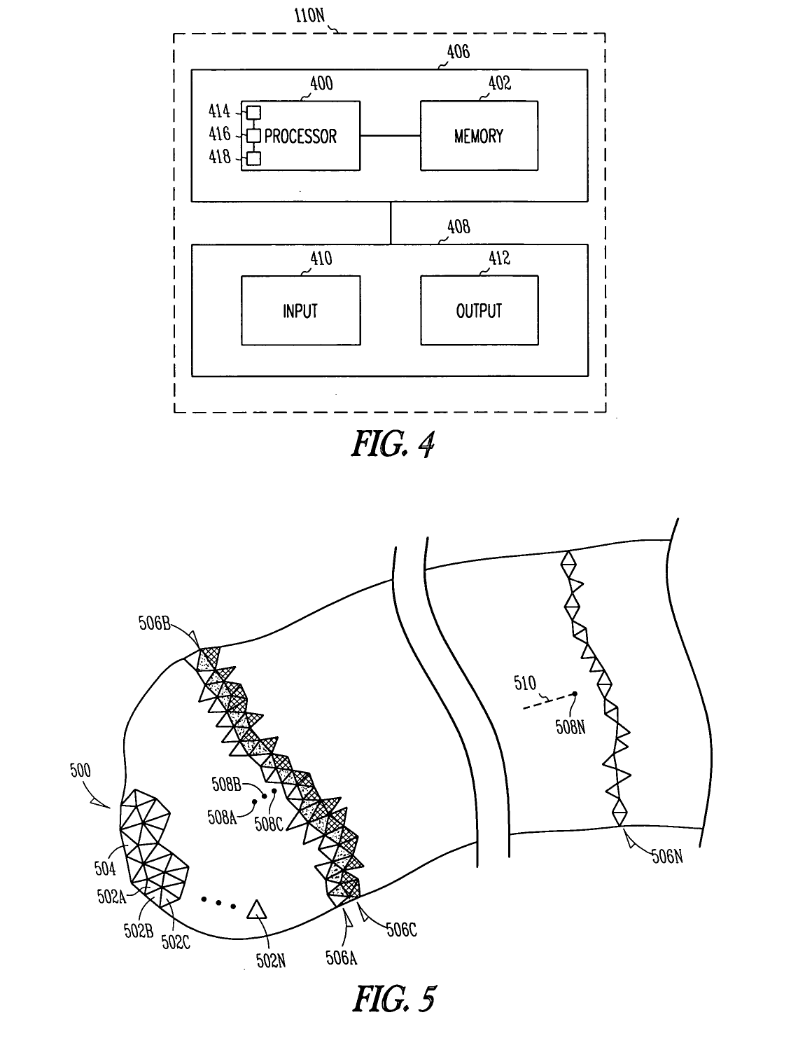

FIG. 4 illustrates portions of a system 110 that is capable of efficient characteristic path generation using a defined 3D surface mesh of a scanned 3D volumetric representation of a biological structure. In this example, a processor 400 is connected to interact with a memory 402. A wide array of possible processor and memory combinations are available. Processors 400 may include commercial units (e.g., Pentium, Motorola 68000 series, PowerPC) or specialized units made for use in specific applications. The memory 402 can include any memory, such as solid-state, magnetic, or optical media.

A user-interface 408 is typically connected to the processor-memory combination 406. This user-interface 408 typically includes an input device 410 and an output device 412. The input device 410 can be one or more of a keyboard, a mouse, a touchpad, a microphone, a sensing device, a monitoring device, or any other type of device that allows a computer to receive commands or input data from a user. The output device 412 can include such things as a monitor, a printer, a speaker, or any other type of device that allows a system to represent resultant data to the user.

In one example, a user can input a command with an input device 410 that indicates an input segmentation. A segmentation is a result of a process that analyzes the image intensity of a scan to determine what portions are “inside” the object and produces a volumetric virtual object, which is typically represented by a collection of voxels. The segmentation is then used by the processor-memory combination 406 to generate a characteristic path based on a surface mesh of the segmented biological structure.

First, a surface mesh is generated by the Surface Mesh Generator module 414. Then, the shapes on the surface mesh are assigned distance values and grouped by the Ring Generator module 416. Finally, a characteristic path is computed in the Characteristic Path Generator module 418. Then, in one example, the resulting characteristic path is displayed or provided on the output device 412 for the user. In another example, the resulting characteristic path is used in one or more other processes (e.g., a registration process, such as to register between characteristic paths of prone and supine scans) and the results of these processes are typically displayed or produced on the output device 412.

FIG. 5 illustrates a 3D representation of a tubular virtual object, such as a virtual colon, with a surface mesh 500 formed over the surface. In this example, the surface mesh 500 is formed by first segmenting the 3D virtual object and then using an isosurface extraction technique (e.g., Marching Cubes, tetrahedronalization, shrink-wrapping, etc.).

Next, an arbitrary reference triangle 504 is selected. In one example, the reference triangle 504 is selected at a location that is at or near an end of the tubular object, such as at or near the cecum or the rectum of the colon. After selecting the reference triangle 504, geodesic distance values of other triangles are computed with respect to the reference triangle 504. Then, individual triangles 502A, 502B, 502C, 502N are grouped by their assigned geodesic distance values from the reference triangle 504.

By grouping individual connected triangles 502A, 502B, 502C, . . . , 502N, by their assigned geodesic distance values from the reference triangle 504, shapes that approximate rings 506A, 506B, 506C, . . . , 506N, are formed on the surface mesh 500. Each ring's corresponding centroid 508A, 508B, 508C, . . . , 508N, is calculated. The collection of such centroids 508 form a characteristic path 510.

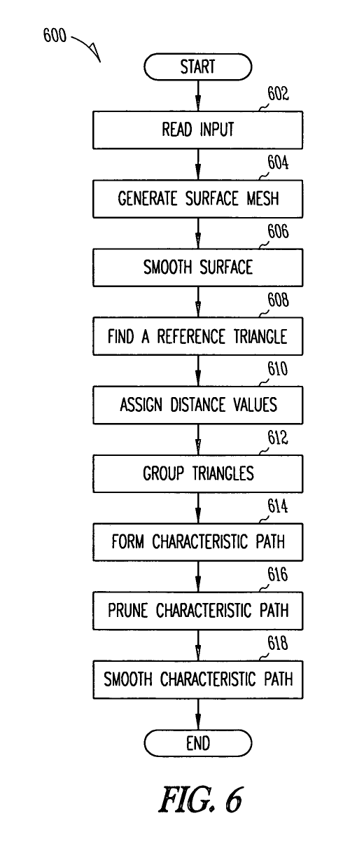

FIG. 6 is a flowchart illustrating an example of a method 600 for determining a characteristic path using a defined surface mesh 500 of a scanned biological structure. In this example, at 602, the first step is to read any input parameters. This typically includes an input parameter identifying a particular segmentation for which a characteristic path is desired. Some illustrative examples of other parameters are listed in Table 1 and are discussed below.

TABLE 1
Example of Optional Input Parameters

| Input Parameter | Description |
|---|---|
| Initial Position | This parameter is used to define an initial location. |
| Ring Width | This parameter defines how many geodesic distance |
| | values to group together to form a circumferential |
| | shape. |
| Type of Biological | This parameter controls the amount of pruning |
| Object | performed. It may also be used to set a default Ring |
| | Width value. |
| Path Smoothing | This parameter controls an amount of path |
| | smoothing to be performed. |
| Surface Smoothing | This parameter controls a desired surface smoothing. |

The “Initial Position” parameter can be used to specify an initial area to search for a triangle to use as the reference triangle 504, which is the beginning of the characteristic path 510. If an initial location is not provided, the method will automatically determine a reference triangle 504 to be used. The “Ring Width” parameter controls how wide a typical ring 506 is by grouping more or fewer triangles together into the same ring 506. To an extent, wider rings 506 are advantageous to avoid frequent spurious branching of the characteristic path 510. The “Path Smoothing” parameter controls the level of smoothing applied to the characteristic path 510. If the “Ring Width” parameter is large, the centroids 508A, 508B, 508C, . . . , 508N, are spaced a significant distance apart from each other. This typically results in a coarse characteristic path 510. In one example, the “Path Smoothing” parameter controls the application of a Gaussian kernel along the path 510 to obtain a smoother representation of the characteristic path 510.

These parameters may typically be used individually or in combination with each other. In some examples, one or more parameters may have an effect on others. For example, when the “Type of Biological Object” parameter is set to “colon,” then the “Ring Width” and “Path Smoothing” parameters are automatically altered from default generic values to pre-determined suitable values for colon virtual objects, e.g., based on previous experiments. This dependent relationship may be included in the software, or it could be another initial set of parameters.

At 604, a geometric surface mesh is generated. In one example, this surface mesh is created using triangular mesh elements. The triangular mesh elements can be created using a Marching Cubes technique. The Marching Cubes technique is fast, robust, and yields triangles of approximately uniform size. In an alternative example, an isosurface extraction technique (e.g., tetrahedronalization, shrink-wrapping, etc.) is used to produce the triangular mesh 500. The particular isosurface extraction algorithm may be selected such that it produces approximately uniformly-specified shapes. This results in rings without large deformations, which, in turn, produces a more accurate characteristic path.

While this example uses a triangular elements to form the surface mesh 500, other meshes could be used instead. Other examples use a surface mesh defined by any n-sided polygon. Further examples use different shaped polygons to define the surface mesh 500. However, constructing these other types of meshes is typically more complex than constructing a surface mesh 500 from only triangular elements.

At 606, surface smoothing may optionally be performed, such as to reduce the blocky nature of the triangular surface mesh 500. Surface smoothing may result in a smoother characteristic path 510, which may increase the accuracy of its representation. In one example, this surface smoothing operation uses the “Surface Smoothing” parameter (see Table 1). This parameter can be implemented by defining the number of times the smoothing operation is performed, or by providing a textual description (e.g. “very smooth,” “mostly smooth,” “rough”) of the desired surface smoothness that would be interpreted by software to generate an appropriately smooth surface texture. In addition, a default value may be provided to control the smoothing operation when the “Surface Smoothing” parameter is left unspecified by the user.

In one example, surface smoothing is accomplished by replacing each vertex on the surface mesh 500 with an average of all centroids of its the triangles that are adjacent to that vertex. The result of this replacement is a surface mesh with fewer local extreme maximums and minimums. In one example, the “Surface Smoothing” parameter controls the number of iterations of this replacement function, which would further reduce local maximums and minimums, producing a less jaggy surface mesh.

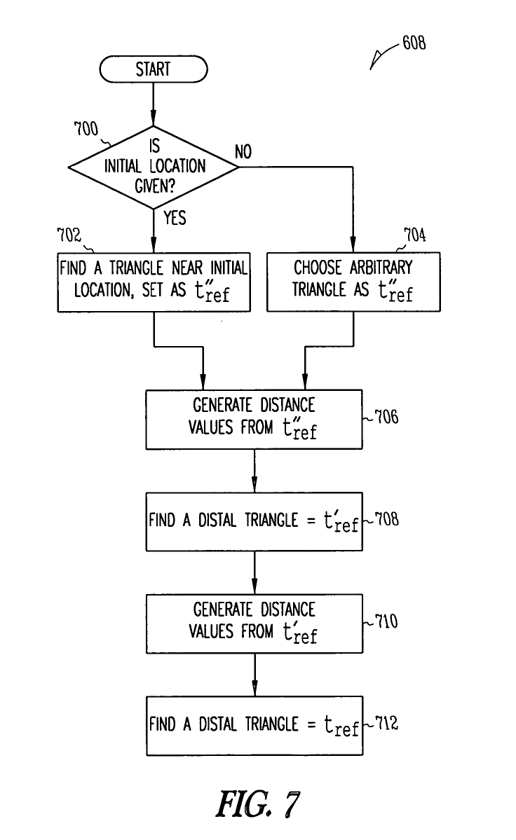

At 608, a reference shape is determined. In this example, the reference shape is the reference triangle τ_{ref}, 504, such as discussed further below with respect to FIG. 7.

At 610, the surface mesh 500 is traversed, and a final set of geodesic distance values are assigned for each triangular mesh element with respect to the reference triangle τ_{ref}.

At 612, after all triangles in the mesh have been assigned distance values, triangles that are connected to each other are grouped based on their distance values. In one example, all triangles with a like distance value are grouped together. For example, all connected triangles with a distance value of seven are combined to represent a level set. The result of this grouping is roughly in the shape of a ring conforming to the circumference of the 3D virtual object. For example, FIG. 5 illustrates level sets, 508A, 508B, 508C, . . . , 502N, which are groups of triangles with like distance values. In one example, connectivity of the triangles is checked by analyzing the set of triangles that comprise the current level set. Optionally, connectivity could be tracked during other steps, for example, at the time the distance values are assigned. In this example, connectivity is analyzed using a region growing function. The function uses an arbitrary initial triangle and propagates to all other triangles in the set of triangles that are in the current level set, tracking those that are connected. One triangle is considered connected to another if they share either a vertex or an edge, or if they can be joined by a series of inter-connected triangles.

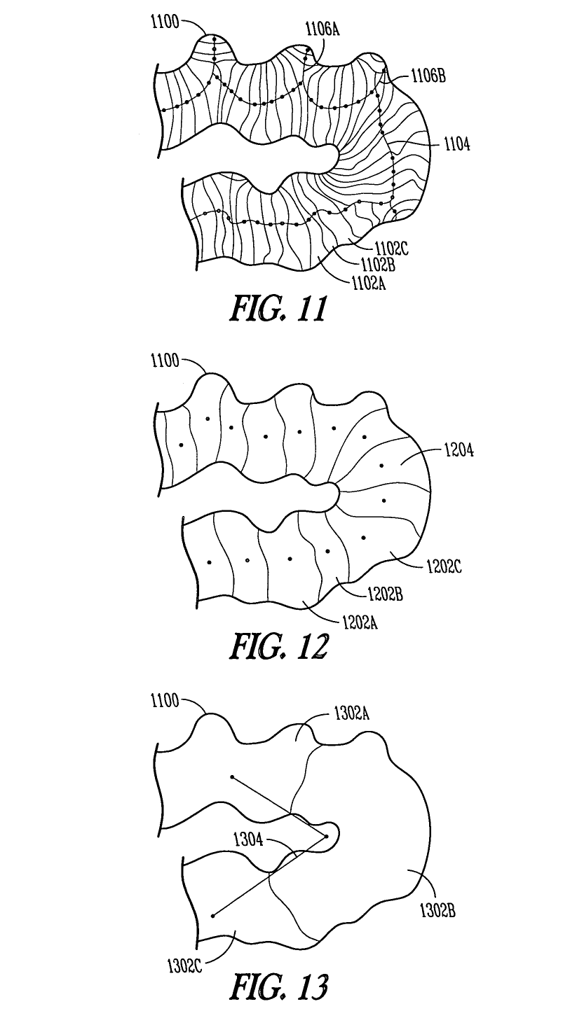

In other examples, triangles are grouped by combining two or more level sets. This method produces wider rings. Optionally, the number of level sets to group together can be controlled by the “Ring Width” parameter (see Table 1). For example, if the “Ring Width” parameter value was three, then triangles with the geodesic distance values of zero, one, and two would be grouped together; triangles with the geodesic distance values of three, four, and five would be grouped together; and so on. For example, FIG. 11 illustrates a virtual 3D object 1100 with narrow rings 1102A, 1102B, 1102C superimposed on its surface. Using a smaller “Ring Width” parameter would typically result in a characteristic path 1104 with a higher resolution, but may also result in a jagged, jittery path 1104 with meaningless branches 1106A, 1106B. Using multiple distance values to define the rings will typically smooth out some of the jaggedness of the characteristic path 1104 and eliminate more dead-end branches. FIG. 12 illustrates the same virtual 3D object 1100 of FIG. 11, but with wider rings 1202A, 1202B, 1202C. In this example, because of the higher Ring Width parameter, and the resulting wider rings 1202A, 1202B, 1202C, there are no dead-end branches. In general, wider rings typically reduce the number of dead-end branches. However, if the “Ring Width” range is too high, there is an increased likelihood that a characteristic path 1204 will travel outside the virtual 3D object 1100, as shown in FIG. 13. FIG. 13 illustrates the same virtual 3D object 1100 as shown in FIGS. 11-12, but with extremely wide rings 1302A, 1302B, 1302C, which result in a path 1304 that exits and reenters the virtual 3D object 1100.

Returning to the flow chart of FIG. 6, at 614, beginning at the reference triangle 504, each ring's centroid 508A, 508B, 508C, . . . , 508N is calculated, and these centroids are connected to create the characteristic path 510. In this example, a ring's centroid is calculated by averaging the centroids of the triangular surface elements that define the ring. In other examples, a ring's centroid is calculated using the vertices of the triangular elements that define the ring.

At 616, after the characteristic path 510 is generated, the characteristic path 510 is pruned by removing any branches that are shorter than a threshold value. In one example, the threshold value is specified by an input parameter. Other examples could include receiving the parameter from a user during runtime execution; dynamically calculating the threshold value as a function of the object's radius, width, circumference, or other feature; using a default value; or using the type of object being mapped as a factor in establishing the threshold value. In one example, if the initial parameter “Type of Biological Object” (see Table 1) is provided, an appropriate pruning threshold value is set based on that parameter. Anatomical objects that have no inherent branching, such as a colon, may have a very high threshold value to automatically prune practically every branch. In contrast, objects that are highly figured, for example lung passages or blood vessels, typically have a low threshold value to preserve meaningful branches.

At 618, an optional characteristic path smoothing may be performed to produce a more accurate representation. In one example, the smoothing is accomplished by applying a Gaussian kernel along the characteristic path 510. A typical Gaussian kernel application adjusts a given point in space by taking a weighted average of its neighbors.

In this case, each point on the characteristic path is adjusted by analyzing a certain number of neighboring points along the path and giving more weight to the nearer neighbors than to the farther neighbors in the weighted average. An optional parameter, “Path Smoothing” (see Table 1), may be provided by the user to establish the degree of desired smoothing. In one example, the value of the “Path Smoothing” parameter establishes the standard deviation of the Gaussian smoothing kernel. The standard deviation will define the range of the neighbors considered in the weighted average and the weights themselves.

FIG. 7 is a flowchart illustrating, in more detail, the finding of a reference triangle 504, such as described above at 608 of the flow chart of FIG. 6. In the example of FIG. 7, at 700, it is determined whether an initial location was provided by the user. If such an initial location is available, then, at 702, a triangle near the initial location is determined and saved as triangle τ′_{ref}. In one example, the triangle τ′_{ref} is the closest triangle to the given initial location. At 704, if an initial location is not provided, then an initial triangle τ′_{ref} is arbitrarily chosen from the set of triangles that define the surface mesh.

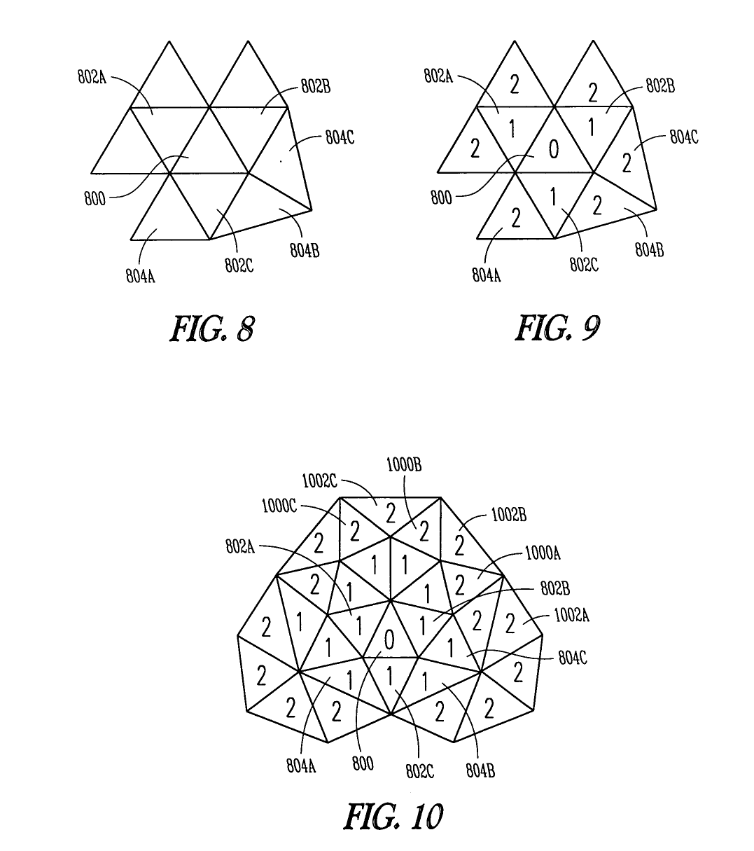

At 706, after determining τ″_{ref}, distance values are then generated, such as by propagating outward from triangle τ′_{ref}. FIG. 8 illustrates an example of this assignment propagation. Starting from an initial triangle 800, triangles on each edge 802A, 802B, and 802C, which are not currently assigned a geodesic distance value, are assigned a geodesic distance value with respect to the initial triangle 800. In this case, the triangles are assigned the geodesic distance value of one, defining a first level set. After each neighboring triangle's distance is computed and assigned, the propagation moves out to the next set of unassigned neighboring triangles, e.g., 804A, 804B, 804C and assigns an incremental distance value of two to this next level set. This propagation is continued until the remaining unassigned triangles in the mesh have been assigned a geodesic distance value. FIG. 9 illustrates an example of a partial result of this propagation with exemplary distance values displayed in each triangle. FIG. 10 illustrates an example of a partial result of an alternative method of propagation beginning with a initial triangle 800 and assigning to neighbors that share vertices (e.g., 802A, 802B, 802C, 804A, 804B, 804C), an incremental distance value defining a first level set. The second level set is then defined by assigned the neighbors that share vertices (e.g., 1000A, 1000B, 1000C, 1002A, 1002B, 1002C), an incremental distance value with respect to the first level set, in this instance the value of two. The propagation continues in this manner until all triangles are assigned a distance value. This method may produce smoother rings, but it is more computationally intensive.

At 708, a distal (farthest) triangle (e.g., a triangle with a maximum geodesic distance value) is found and saved as triangle τ′_{ref}. In this example, if multiple triangles share the maximum geodesic distance value, then one such triangle is arbitrarily chosen as the triangle τ′_{ref}. Other examples may calculate a “best” distal triangle from the set of distal triangles based on a global location, distance from each other, distance from a reference point, or one or more other factors. At 710, the distance values are again calculated with respect to τ′_{ref}. Then, at 712, a second distal triangle is found and saved as the reference triangle τ_{ref}. In this example, if multiple triangles share the maximum geodesic distance value with respect to τ′_{ref}, then the triangle that is closest to τ′_{ref} is assigned τ_{ref}. In other examples, an arbitrary triangle may be chosen from the set of distal triangles to define τ_{ref}.

In this example, two separate traversals of the object are used to determine the reference triangle. In other examples, fewer or more scans could be used. If a user specifies an initial location, an even number of traversals will advantageously orient the beginning of the resultant characteristic path 510 near such location provided by the user.

The generated characteristic path 510 is a representation of the scanned object. The use of two or more of these paths, when appropriately scaled and aligned, may be used to register and correlate several paths for further use in virtual colonoscopies or other virtual endoscopies.

Another possible use of a characteristic path is to assist in the reconstruction of virtual colon. Because of muscle contractions or other confounding factors, scans of a colon may produce what appears to be a physically segmented structure. By first generating a characteristic path for each segment, the entire colon can then be reconstructed by using each individual path.

It is to be understood that the above description is intended to be illustrative, and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, various features may be grouped together to streamline the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus the following claims are hereby incorporated into the Detailed Description, with each claim standing on its own as a separate embodiment.

What is claimed is:

1. A computer-assisted method of calculating a characteristic path of a three-dimensional object represented by volumetric imaging data, the method comprising:
generating a geometric surface mesh of one or more geometric shapes;
designating a reference geometric shape;
assigning distance values to the geometric shapes on the geometric surface mesh in relation to the reference geometric shape;
grouping the geometric shapes to form cross-sectional shapes that approximate circumferences of the three-dimensional object;
calculating centroids of the cross-sectional shapes; and
combining the centroids of the cross-sectional shapes to form the characteristic path.

2. The method of claim 1, comprising smoothing the geometric surface mesh.

3. The method of claim 1, wherein the generating the geometric surface mesh comprises generating a surface mesh comprising triangles as elements of the surface mesh.

4. The method of claim 3, wherein the assigning distance values comprises:
identifying a set of unassigned triangles that are adjacent to an edge of any triangle in a current level set; and
assigning the set of triangles an incremental distance value in relation to the current level set.

5. The method of claim 3, comprising:
identifying a set of unassigned triangles that are adjacent to a vertex of any triangle in the current level set; and
assigning the set of triangles an incremental distance value in relation to the current level set.

6. The method of claim 1, wherein the grouping the geometric shapes comprises combining geometric shapes that have a like distance value from the reference geometric shape.

7. The method of claim 6, wherein the grouping the geometric shapes comprises combining geometric shapes that are connected to each other.

8. The method of claim 1, wherein the grouping geometric shapes comprises combining geometric shapes that have a distance value within a specified range of distance values.

9. The method of claim 8, wherein the grouping the geometric shapes comprises combining geometric shapes that are connected to each other.

10. The method of claim 1, comprising pruning the characteristic path to remove spurious branches.

11. The method of claim 1, comprising smoothing the characteristic path.

12. The method of claim 11, wherein the smoothing is performed using a Gaussian kernel.

13. The method of claim 12, comprising providing a standard deviation of the Gaussian kernel as an initial parameter.

14. The method of claim 1, comprising using the characteristic path to register two or more characteristic paths.

15. The method of claim 1, comprising using the characteristic path to connect two or more volumetric segments.

16. A computer-readable medium including instructions that, when performed by a computer, calculate a characteristic path of a three-dimensional object represented by volumetric imaging data by:
generating a geometric surface mesh of one or more geometric shapes;
designating a reference geometric shape;
assigning distance values to the geometric shapes on the geometric surface mesh in relation to the reference geometric shape;
grouping the geometric shapes to form cross-sectional shapes that approximate the circumferences of the three-dimensional object;
calculating centroids of the cross-sectional shapes; and
combining the centroids of the cross-sectional shapes to form the characteristic path.

17. The computer-readable medium of claim 16, comprising smoothing the geometric surface mesh.

18. The computer-readable medium of claim 16, wherein the generating the geometric surface mesh comprises generating a surface mesh having triangles as elements of the surface mesh.

19. The computer-readable medium of claim 18, wherein the assigning distance values comprises:
identifying a set of unassigned triangles that are adjacent to an edge of any triangle in a current level set; and
assigning the set of triangles an incremental distance value in relation to the current level set.

20. The computer-readable medium of claim 18, comprising:
identifying a set of unassigned triangles that are adjacent to a vertex of any triangle in the current level set; and
assigning the set of triangles an incremental distance value in relation to the current level set.

21. The computer-readable medium of claim 16, wherein the grouping the geometric shapes comprises combining geometric shapes that have a like distance value from the reference geometric shape.

22. The method of claim 21, wherein the grouping the geometric shapes comprises combining geometric shapes that are connected to each other.

23. The computer-readable medium of claim 16, wherein the grouping geometric shapes comprises combining geometric shapes that have a distance value within a specified range of distance values.

24. The method of claim 23, wherein the grouping the geometric shapes comprises combining geometric shapes that are connected to each other.

25. The computer-readable medium of claim 16, comprising instructions for pruning the characteristic path to remove spurious branches.

26. The computer-readable medium of claim 16, comprising instructions for smoothing the characteristic path.

27. The computer-readable medium of claim 26, wherein the smoothing is performed using a Gaussian kernel.

28. The computer-readable medium of claim 27, comprising instructions for providing a standard deviation of the Gaussian kernel as an initial parameter.

29. A computer-assisted method of calculating a characteristic path of a biological structure represented by volumetric imaging data, the method comprising:
generating a triangular surface mesh;
choosing a reference triangle from a set of all triangles in the triangular surface mesh;
generating a relative distance value of every triangle in the set of all triangles in the triangular surface mesh in relation to the reference triangle;
grouping triangles to form rings that approximate cross-sectional circumferences of the structure along a longitudinal axis of the structure;
calculating centroids of the rings;
concatenating the centroids of the rings to form the characteristic path;
pruning the characteristic path to remove branches shorter than a threshold length; and
smoothing the characteristic path.

30. The method in claim 29, wherein the generating a triangular surface mesh includes using isosurface extraction.

31. The method in claim 30, wherein the generating a triangular surface mesh includes using a Marching Cubes technique.

32. The method in claim 29, wherein the calculating the centroids of the rings is performed by using the centroid of each triangle in a particular ring.

33. The method in claim 29, wherein the calculating the centroids of the rings is performed by using the vertices of each triangle in a particular ring.

34. The method in claim 29, wherein the grouping triangles to form rings is performed by grouping triangles with the same relative distance values.

35. The method of claim 34, wherein the grouping triangles comprises grouping triangles that are connected to each other.

36. The method in claim 29, wherein the grouping triangles to form rings is performed by grouping triangles within specified ranges of distance values.

37. The method of claim 36, wherein the grouping triangles comprises grouping triangles that are connected to each other.

38. A computer-assisted method of calculating a characteristic path of a colon represented by a given segmentation of volumetric imaging data, the method comprising:
generating a triangular surface mesh using a Marching Cubes technique;
determining a reference triangle to be used as a beginning of the characteristic path;
assigning a geodesic distance value of other triangles from the reference triangle;
grouping connected triangles together according to their geodesic distance values to form a set of rings that approximate cross-sectional circumferences of the colon;
determining a centroid of each ring by using a set of centroids of all triangles in a particular ring;
concatenating the centroids of each ring to form the characteristic path; and
deleting branches that do not meet a minimum length.

39. The method of claim 38, wherein the determining the reference triangle comprises:
determining an arbitrary initial triangle chosen from a set of all triangles in the triangular surface mesh;
assigning a first geodesic distance value of other triangles from the arbitrary initial triangle;
determining a first distal triangle by finding a triangle with a maximum distance value;
assigning a second geodesic distance value of other triangles from the first distal triangle;
determining a second distal triangle;
assigning the reference triangle to the second distal triangle.

40. The method of claim 38, wherein the determining the reference triangle comprises:
receiving an initial location from a user;
determining an initial triangle near the initial location;
assigning a first geodesic distance value of other triangles from the initial triangle;
determining a first distal triangle by finding a triangle with a maximum distance value;
assigning a second geodesic distance value of other triangles from the first distal triangle;
determining a second distal triangle; and
assigning the reference triangle to the second distal triangle.

41. The method of claim 38, wherein the determining the reference triangle comprises:
determining an initial triangle;
assigning a geodesic distance value of other triangles from the initial triangle;
determining a distal triangle by finding a triangle with a maximum distance value;
performing zero or more subsequent iterations of determining a successive geodesic distance value of other triangles and finding a corresponding distal triangle; and
assigning the reference triangle to a last distal triangle.

42. The method of claim 38, wherein the grouping triangles together includes grouping triangles with equivalent geodesic distance values.

43. The method of claim 38, wherein the grouping triangles together includes grouping triangles with a specified range of geodesic distance values.

44. The method of claim 38, wherein the deleting branches comprises receiving the minimum length from a user.

45. The method of claim 38, wherein the deleting branches comprises automatically determining the minimum length based on the type of object being mapped.

46. The method of claim 38, comprising smoothing the characteristic path.

47. An apparatus for calculating a characteristic path of a three-dimensional object comprising:
a processor, operable to perform a calculation of the characteristic path using a triangular surface mesh, wherein the calculation uses geodesic distance values assigned to the each triangle in a set of triangles in the triangular surface mesh;
a memory, coupled to the processor, the memory operable for storing data; and
a user-interface that permits a user to store and retrieve information from the memory using the processor.

48. The apparatus of claim 47, wherein the processor groups triangles taken from the set of triangles according to a similar distance value to form one or more circumferential shapes.

49. The apparatus of claim 48, wherein the processor calculates a centroid of each circumferential shape and combines the centroids to form the characteristic path.

50. The apparatus of claim 47, wherein the processor groups triangles taken from the set of triangles according to a specified range of distance values to form one or more circumferential shapes.

51. The apparatus of claim 50, wherein the processor calculates a centroid of each circumferential shape and combines the centroids to form the characteristic path.
